(19) United States
(12) Patent Application Publication
(10) Pub. No.: US 2019/0009341 A1
(43) Pub. Date: Jan. 10, 2019

(54) SILVER ALLOY POWDER AND METHOD FOR PRODUCING SAME

(71) Applicant: DOWA ELECTRONICS MATERIALS CO., LTD., Tokyo (JP)

(72) Inventors: Masahiro YOSHIDA, Tokyo (JP); Yoshiyuki MICHIAKI, Tokyo (JP); Kenichi INOUE, Tokyo (JP)

(73) Assignee: DOWA ELECTRONICS MATERIALS CO., LTD., Tokyo (JP)

(21) Appl. No.: 16/065,834

(22) PCT Filed: Dec. 26, 2016
(86) PCT No.: PCT/JP2016/005220

§ 371 Date: Jun. 25, 2018

(30) Foreign Application Priority Data
Dec. 28, 2015 (JP) 2015-256201
Dec. 21, 2016 (JP) 2016-247325

(51) Int. Cl. B22F 9/08; B22F 1/00; H01B 1/02

(52) U.S. Cl. CPC B22F 9/08; C22C 5/06; H01B 1/02; B22F 1/0011

(57) ABSTRACT

While a molten metal obtained by melting silver and a metal, which is selected from the group consisting of tin, zinc, lead and indium, in an atmosphere of nitrogen is allowed to drop, a high-pressure water (preferably pure water or alkaline water) is sprayed onto the molten metal in the atmosphere or an atmosphere of nitrogen to rapidly cool and solidify the molten metal to produce a silver alloy powder which comprises silver and the metal which is selected from the group consisting of tin, zinc, lead and indium and which has an average particle diameter of 0.5 to 20 μm, the silver alloy powder having a temperature of not higher than 300° C. at a shrinking percentage of 0.5%, a temperature of not higher than 400° C. at a shrinking percentage of 1.0% and a temperature of not higher than 450° C. at a shrinking percentage of 1.5% in a thermomechanical analysis.

### TECHNICAL FIELD

The present invention relates generally to a silver alloy powder and a method for producing the same. More specifically, the invention relates to a silver alloy powder suitably used as the material of a baked type conductive paste, and a method for producing the same.

### BACKGROUND ART

Conventionally, metal powders, such as silver powders, are used as the material of a baked type conductive paste for forming electrodes of solar cells, internal electrodes of laminated ceramic electronic parts, such as electronic parts using low-temperature co-fired ceramics (LTCC) and multilayer ceramic inductors (MLCI), external electrodes of laminated ceramic capacitors or inductors, and so forth.

However, since silver has a high melting point of 961° C., if silver powder is used for a backed type conductive paste sintered at a relatively low temperature, there is some possibility that sintering may not sufficiently proceed, so that it is not possible to obtain desired electrical characteristics. In addition, silver powders are expensive, so that it is desired to use a less expensive metal powder.

As one of inexpensive metals having a lower sintering temperature than that of silver, there is proposed a brazing filler metal composed of a melt-extracted sheet material, a thin wire and a fine granule, the brazing filler metal containing, as main component(s), one or more selected from the group consisting of silver, Sn, Sb, Zn and Bi, and the brazing filler metal having a melting point of not higher than 600° C. (see, e.g., Patent Document 1).

### PRIOR ART DOCUMENT(S)

### Patent Document(s)

Patent Document 1: Japanese Patent Laid-Open No. 58-6793 (Page 2).

### SUMMARY OF THE INVENTION

### Problem to be Solved by the Invention

However, since the brazing filler metal of Patent Document 1 does not contain a metal powder having small particle diameters, it is not possible to sufficiently decrease the sintering temperature thereof, so that it is not possible to obtain good conductivities.

It is therefore an object of the present invention to eliminate the aforementioned conventional problems and to provide an inexpensive silver alloy powder having a low sintering temperature, and a method for producing the same.

### Means for Solving the Problem

In order to accomplish the aforementioned object, the inventors have diligently studied and found that it is possible to produce an inexpensive silver alloy having a low sintering temperature, if the silver alloy powder comprises silver and a metal which is selected from the group consisting of tin, zinc, lead and indium, the silver alloy powder having an average particle diameter of 0.5 to 20 μm, and the silver alloy powder having a temperature of not higher than 300° C. at a shrinking percentage of 0.5% in a thermomechanical analysis. Thus, the inventors have made the present invention.

According to the present invention, there is provided a silver alloy powder comprising silver and a metal which is selected from the group consisting of tin, zinc, lead and indium, the silver alloy powder having an average particle diameter of 0.5 to 20 μm, and the silver alloy powder having a temperature of not higher than 300° C. at a shrinking percentage of 0.5% in a thermomechanical analysis.

This silver alloy powder preferably has a temperature of not higher than 400° C. at a shrinking percentage of 1.0% in the thermomechanical analysis, and a temperature of not higher than 450° C. at a shrinking percentage of 1.5% in the thermomechanical analysis. The silver alloy powder preferably has an oxygen content of not higher than 6% by weight, and a carbon content of not higher than 0.5% by weight. The silver alloy powder preferably has a BET specific surface area of 0.1 to 3.5 m²/g, and a tap density of not less than 2.5 g/cm³. When the silver alloy powder is an alloy powder of tin and silver, it preferably has a tin content of 65 to 75% by weight.

According to the present invention, there is provided a method for producing a silver alloy powder, the method comprising the steps of: preparing a molten metal by melting silver and a metal, which is selected from the group consisting of tin, zinc, lead and indium, in an atmosphere of nitrogen; and rapidly cooling and solidifying the molten metal by spraying a high-pressure water onto the molten metal while the molten metal is allowed to drop.

In this method for producing a silver alloy powder, the high-pressure water is preferably pure water or alkaline water, and preferably sprayed onto the molten metal in the atmosphere or an atmosphere of nitrogen.

According to the present invention, there is provided a conductive paste wherein the above-described silver alloy powder is dispersed in an organic component. This conductive paste is preferably a baked type conductive paste.

According to the present invention, there is provided a method for producing a conductive film, the method comprising the steps of: applying the above-described baked type conductive paste on a substrate; and thereafter, firing the paste to produce a conductive film.

Throughout the specification, the expression “average particle diameter” means a volume-based particle diameter (D₅₀ diameter) corresponding to 50% of accumulation in cumulative distribution, which is measured by means of a laser diffraction particle size analyzer (by HELOS method).

### Effects of the Invention

According to the present invention, it is possible to provide an inexpensive silver alloy having a low sintering temperature, and a method for producing the same.

### BRIEF DESCRIPTION OF THE DRAWINGS

FIG. 1 is a graph showing a shrinking percentage of each of silver alloy powders in Examples 1 through 10 and a silver powder in Comparative Example with respect to temperature in a thermomechanical analysis (TMA);

FIG. 2 is a graph showing the elemental analysis profile of the silver alloy powder in Example 3 with respect to the depth directions by means of an X-ray photoelectron spectroscopic analyzer (XPS); and

FIG. 3 is a graph showing a volume resistivity of each of conductive films obtained by firing conductive pastes at 780° C., and 820° C., respectively, the conductive pastes being prepared by using the silver alloy powders in Examples 2, 3 and 6, the silver powder in Comparative Example, and a tin powder, respectively.

### MODE FOR CARRYING OUT THE INVENTION

The preferred embodiment of a silver alloy powder according to the present invention is a powder of an alloy of silver and a metal which is selected from the group consisting of tin, zinc, lead and indium, the silver alloy powder having an average particle diameter of 0.5 to 20 μm (preferably 0.5 to 15 μm and more preferably 0.5 to 10 μm), and the silver alloy powder having a temperature of not higher than 300° C. (preferably not higher than 290° C.) at a shrinking percentage of 0.5% in a thermomechanical analysis.

This silver alloy powder preferably has a temperature of not higher than 400° C. (more preferably has a temperature of not higher than 360° C.) at a shrinking percentage of 1.0% in the thermomechanical analysis, and preferably has a temperature of not higher than 450° C. (more preferably has a temperature of not higher than 420° C.) at a shrinking percentage of 1.5% in the thermomechanical analysis.

The content of oxygen in the silver alloy powder is preferably not higher than 6% by weight, more preferably not higher than 4% by weight, and most preferably not higher than 2% by weight, so as to be able to obtain good conductivity when the silver alloy powder is used as the material of a baked type conductive paste.

The content of carbon in the silver alloy powder is preferably not higher than 0.5% by weight, and more preferably not higher than 0.2% by weight. Furthermore, if the content of carbon in the silver alloy powder is low, when the silver alloy powder is used as the material of a baked type conductive paste, it is possible to suppress the production of gases during the firing of the conductive paste to suppress the deterioration of adhesion of a conductive film to a substrate while preventing cracks from being formed in the conductive film.

The BET specific surface area of the silver alloy powder is preferably 0.1 to 3.5 m²/g, and more preferably 1 to 3.5 m²/g.

The tap density of the silver alloy powder is preferably not less than 2.5 g/cm³, and more preferably 3 to 5 g/cm³.

When the silver alloy powder is an alloy powder of silver and tin, the content of tin in the silver alloy powder is preferably 45% by weight or more in order to decrease the content of expensive silver, and preferably 80% by weight or less so as to be able to obtain good conductivity when the silver alloy powder is used as the material of a baked type conductive paste. The content of oxygen in the silver alloy powder, which is the alloy powder of silver and tin, is preferably 2% by weight or less. The thickness of an oxide film on the surface of the silver alloy powder is preferably 45 to 100 nm. If a surface oxide film having such a thickness is formed, there is some possibility that the surface oxide film may serve as a sintering additive to decrease the sintering temperature. Furthermore, throughout the specification, the thickness of the surface oxide film means the thickness of a portion in which oxygen atomic percentage in the surface portion of the silver alloy powder exceeds 9% in the element distribution spectrum of the silver alloy powder by means of an X-ray photoelectron spectroscopic analyzer (XPS).

The shape of the silver alloy powder may be any one of various granular shapes, such as spherical shapes or flake shapes, and indefinite shapes which are irregular shapes.

The above-described preferred embodiment of the silver alloy powder can be produced by the preferred embodiment of a method for producing a silver alloy powder according to the present invention.

In the preferred embodiment of a method for producing a silver alloy powder according to the present invention, a molten metal prepared by melting silver and a metal, which is selected from the group consisting of tin, zinc, lead and indium, in an atmosphere of nitrogen is rapidly cooled and solidified by spraying a high-pressure water (which is preferably pure water or alkaline water) onto the molten metal (preferably at a water pressure of 30 to 200 MPa in the atmosphere or an atmosphere of nitrogen) while the molten metal is allowed to drop.

If a silver alloy powder is produced by a so-called water atomizing method for spraying a high-pressure water, it is possible to obtain a silver alloy powder having small particle diameters. For that reason, if such a silver alloy powder is used as the material of a baked type conductive paste, the sintering temperature thereof can be lowered. For example, the silver alloy powder can be sufficiently sintered at a low temperature of about 500° C., so that it is possible to obtain good conductivity. On the other hand, tin, zinc, lead and indium are easily oxidized in comparison with silver. For that reason, if tin, zinc, lead or indium, together with silver, is melted in an atmosphere containing oxygen, the content of oxygen in the silver alloy powder produced by the water atomizing method is easily increased, so that there is a problem in that the sintering temperature is enhanced to easily decrease conductivity. However, if tin, zinc, lead or indium, together with silver, is melted to produce a silver alloy powder by the water atomizing method, it is possible to decrease the content of oxygen therein.

The preferred embodiment of a silver alloy powder according to the present invention can be used as the material of a conductive paste (wherein the silver alloy powder is dispersed in an organic component). In particular, since the preferred embodiment of a silver alloy powder according to the present invention has a low sintering temperature, it is preferably used as the material of a baked type conductive paste having a low firing temperature (the paste being preferably fired at a low temperature of about 300 to 800° C., and more preferably fired at a low temperature of about 400 to 700° C.). Furthermore, since the preferred embodiment of a silver alloy powder according to the present invention can be used as the material of a baked type conductive paste having a low firing temperature, it may be used as the material of a curable resin type conductive paste (which is heated at a lower temperature than the firing temperature of a conventional baked type conductive paste to form a conductive film). As the material of a conductive paste, two or more of Ag—Sn, Ag—In, Ag—Zn and Ag—Pb alloy powders in the preferred embodiment of a silver alloy powder according to the present invention may be mixed to be used, and the preferred embodiment of a silver alloy powder according to the present invention may be mixed with other metal powders having different shapes and particle diameters to be used.

When the preferred embodiment of a silver alloy powder according to the present invention is used as the material of a conductive paste (such as a baked type conductive paste), the components of the conductive paste contains the silver alloy powder and an organic solvent (such as saturated aliphatic hydrocarbons, unsaturated aliphatic hydrocarbons, ketones, aromatic hydrocarbons, glycol ethers, esters, and alcohols). If necessary, the components of the conductive paste may contain vehicles, which contain a binder resin (such as ethyl cellulose or acrylic resin) dissolved in an organic solvent, glass frits, inorganic oxides, dispersing agents, and so forth.

The content of the silver alloy powder in the conductive paste is preferably 5 to 98% by weight and more preferably 70 to 95% by weight, from the points of view of the conductivity and producing costs of the conductive paste. The silver alloy powder in the conductive paste may be mixed with one or more of other metal powders (such as silver powder, an alloy powder of silver and tin, and tin powder) to be used. The metal powder(s) may have different shapes and particle diameters from those of the preferred embodiment of a silver alloy powder according to the present invention. The average particle diameter of the metal powder(s) is preferably 0.5 to 20 μm in order to fire the conductive paste at a low temperature. The content of the metal powder(s) in the conductive paste is preferably 1 to 94% by weight and more preferably 4 to 29% by weight. Furthermore, the total of the contents of the silver alloy powder and the metal powder(s) in the conductive paste is preferably 60 to 98% by weight. The content of the binder resin in the conductive paste is preferably 0.1 to 10% by weight and more preferably 0.1 to 6% by weight, from the points of view of the dispersibility of the silver alloy powder in the conductive paste and of the conductivity of the conductive paste. Two or more of the vehicles containing the binder resin dissolved in the organic solvent may be mixed to be used. The content of the glass frit in the conductive paste is preferably 0.1 to 20% by weight and more preferably 0.1 to 10% by weight, from the points of view of the sinterability of the conductive paste. Two or more of the glass frits may be mixed to be used. The content of the organic solvent in the conductive paste (the content containing the organic solvent of the vehicle when the conductive paste contains the vehicle) is preferably 0.8 to 20% by weight and more preferably 0.8 to 15% by weight, in view of the dispersibility of the silver alloy powder in the conductive paste and of the reasonable viscosity of the conductive paste. Two or more of the organic solvents may be mixed to be used.

Such a conductive paste can be prepared by putting components, the weights of which are measured, in a predetermined vessel to preliminarily knead the components by means of a Raikai mixer (grinder), an all-purpose mixer, a kneader or the like, and thereafter, kneading them by means of a three-roll mill. Thereafter, an organic solvent may be added thereto to adjust the viscosity thereof, if necessary. After only the glass frit, inorganic oxide and vehicle may be kneaded to decrease the grain size thereof, the silver alloy powder may be finally added to be kneaded.

If this conductive paste is fired after it is applied on a substrate so as to have a predetermined pattern shape by dipping or printing (such as metal mask printing, screen printing, or ink-jet printing), a conductive film can be formed. When the conductive paste is applied by dipping, a substrate is dipped into the conductive paste to form a coating film, and then, unnecessary portions of the coating film are removed by photolithography utilizing a resist or the like, so that it is possible to form a coating film having a predetermined pattern shape on the substrate.

The firing of the conductive paste applied on the substrate may be carried out in the atmosphere or in a non-oxidizing atmosphere, such as an atmosphere of nitrogen, argon, hydrogen or carbon monoxide. Since the preferred embodiment of a silver alloy powder according to the present invention has a low sintering temperature, it is possible to lower the firing temperature of the conductive paste (to be preferably a low temperature of about 300 to 700° C., and more preferably a low temperature of about 400 to 600° C.). Furthermore, the firing temperature of the conductive paste may be a usual firing temperature (of about 700 to 900° C.). Before the firing of the conductive paste, volatile constituents, such as organic solvents, in the conductive paste may be removed by pre-drying by vacuum drying or the like.

### EXAMPLES

Examples of a silver alloy powder and a method for producing the same according to the present invention will be described below in detail.

### Example 1

While a molten metal obtained by heating 7.5 kg of shot silver and 2.5 kg of shot tin to 1100° C., in an atmosphere of nitrogen was allowed to drop from the lower portion of a tundish, a high-pressure water was sprayed onto the molten metal at a water pressure of 150 MPa and a water flow rate of 160 L/min. in the atmosphere by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver alloy powder (Ag—Sn alloy powder). Furthermore, an aqueous alkaline solution (pH=10.26) prepared by adding 157.55 g of sodium hydroxide to 21.6 m³ of pure water was used as the high-pressure water.

With respect to the silver alloy powder thus obtained, the BET specific surface area, tap density, oxygen content, carbon content and particle size distribution thereof were obtained, and the alloy composition analysis and thermomechanical analysis (TMA) thereof were carried out.

The BET specific surface area was measured by means of a BET specific surface area measuring apparatus (4-Sorb US produced by Yuasa Ionics Co., Ltd.) using the single point BET method, while a mixed gas of nitrogen and helium (N₂: 30% by volume, He: 70% by volume) was caused to flow in the apparatus after nitrogen gas was caused to flow in the apparatus at 105° C. for 20 minutes to deaerate the interior of the apparatus. As a result, the BET specific surface area was 0.92 m²/g.

The tap density (TAP) was obtained by the same method as that disclosed in Japanese Laid-Open No. 2007-263860 as follows. First, a closed-end cylindrical die having an inside diameter of 6 mm was filled with the silver alloy powder to form a silver alloy powder layer. Then, a pressure of 0.160 N/m² was uniformly applied on the top face of the silver alloy powder layer, and thereafter, the height of the silver alloy powder layer was measured. Then, the density of the silver alloy powder was obtained from the measured height of the silver alloy powder layer and the weight of the filled silver alloy powder. The density of the silver alloy powder thus obtained was assumed as the tap density of the silver alloy powder. As a result, the tap density was 3.6 g/cm³.

The oxygen content was measured by means of an oxygen/nitrogen/hydrogen analyzer (EMGA-920 produced by HORIBA, Ltd.). As a result, the oxygen content was 0.32% by weight.

The carbon content was measured by means of a carbon/sulfur analyzer (EMIA-220V produced by HORIBA, Ltd.). As a result, the carbon content was 0.01% by weight.

The particle size distribution was measured at a dispersing pressure of 5 bar by means of a laser diffraction particle size analyzer (HELOS particle size analyzer produced by SYMPATEC GmbH (HELOS & RODOS (dry dispersion in the free aerosol jet))). As a result, the particle diameter (D₁₀) corresponding to 10% of accumulation in cumulative distribution of the silver alloy powder was 0.9 # m, the particle diameter (D₅₀) corresponding to 50% of accumulation in cumulative distribution of the silver alloy powder was 2.2 μm, and the particle diameter (D₉₀) corresponding to 90% of accumulation in cumulative distribution of the silver alloy powder was 4.2 μm.

The alloy composition analysis was carried out by means of an inductively coupled plasma (ICP) emission analyzer (SPS3520V produced by Hitachi High-Tech Science Corporation). As a result, the content of Ag in the silver alloy powder was 74% by weight, and the content of Sn therein was 24% by weight.

The thermomechanical analysis (TMA) was carried out as follows. First, the silver alloy powder was put in an alumina pan having a diameter of 5 mm and a height of 3 mm to be set on a sample holder (cylinder) of a thermomechanical analyzer (TMA) (TMA/SS6200 produced by Seiko Instruments Inc.). Then, a measuring probe was used for applying a load of 0.147 N on the silver alloy powder for one minute to press and harden the powder to prepare a test sample. Then, while nitrogen was caused to flow at a flow rate of 200 mL/min. in the analyzer, a measuring load of 980 mN was applied on the test sample, and the temperature of the test sample was raised at a rate of temperature increase of 10° C./min. from a room temperature to 500° C., to measure the shrinking percentage of the test sample (the shrinking percentage with respect to the length of the test sample at the room temperature). As a result, the temperature of the test sample was 162° C., at a shrinking percentage of 0.5% (expansion rate=−0.5%), the temperature thereof was 268° C., at a shrinking percentage of 1.0% (expansion rate=−1.0%), and the temperature thereof was 335° C., at a shrinking percentage of 1.5% (expansion rate=−1.5%).

### Example 2

A silver alloy powder (Ag—Sn alloy powder) was obtained by the same method as that in Example 1, except that pure water (pH=5.8) was used as the high-pressure water and that the weights of the shot silver and shot tin were 6.5 kg and 3.5 kg, respectively.

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 1.14 m²/g, and the tap density thereof was 3.5 g/cm³. The oxygen content in the silver alloy powder was 0.57% by weight, and the carbon content therein was 0.01% by weight. The particle diameter (D₁₀) corresponding to 10% of accumulation in cumulative distribution of the silver alloy powder was 0.8 μm, the particle diameter (D₅₀) corresponding to 50% of accumulation in cumulative distribution of the silver alloy powder was 1.9 μm, and the particle diameter (D₉₀) corresponding to 90% of accumulation in cumulative distribution of the silver alloy powder was 4.0 μm. The content of Ag in the silver alloy powder was 63% by weight, and the content of Sn therein was 36% by weight. The temperature of the test sample was 142° C. at a shrinking percentage of 0.5%, the temperature thereof was 194° C. at a shrinking percentage of 1.0%, and the temperature thereof was 216° C. at a shrinking percentage of 1.5%.

The thickness of an oxide film on the surface of the silver alloy powder was measured. The measurement of the surface oxide film was carried out with respect to an area having a diameter of 800 μm on the surface of a silver alloy powder sample, by means of an X-ray photoelectron spectroscopic analyzer (ESCA5800 produced by ULBAC-PHI, Inc.) using a monochromatic Al as an X-ray source and using Kα lines. Assuming that the sputtering rate of the sample was 1 nm/min. in terms of SiO₂ and that the thickness of the surface oxide film was the thickness of a portion having an oxygen atomic percentage exceeding 9% in the surface portion of the silver alloy powder in the obtained elemental analysis profile with respect to the depth directions. As a result, the thickness of the surface oxide film was 18 nm.

### Example 3

A silver alloy powder (Ag—Sn alloy powder) was obtained by the same method as that in Example 1, except that the weights of the shot silver and shot tin were 1.35 kg and 1.65 kg, respectively.

With respect to the silver alloy powder thus obtained, the BET specific surface area, tap density, oxygen content, carbon content and particle size distribution thereof were obtained by the same methods as those in Example 1, the alloy composition analysis and thermomechanical analysis (TMA) thereof were carried out by the same methods as those in Example 1, and the thickness of the surface oxide film was measured by the same method as that in Example 2.

As a result, the BET specific surface area of the silver alloy powder was 1.63 m²/g, and the tap density thereof was 3.3 g/cm³. The oxygen content in the silver alloy powder was 0.76% by weight, and the carbon content therein was 0.01% by weight. The particle diameter (D₁₀) corresponding to 10% of accumulation in cumulative distribution of the silver alloy powder was 0.7 μm, the particle diameter (D₅₀) corresponding to 50% of accumulation in cumulative distribution of the silver alloy powder was 1.8 μm, and the particle diameter (D₉₀) corresponding to 90% of accumulation in cumulative distribution of the silver alloy powder was 4.0 μm. The content of Ag in the silver alloy powder was 45% by weight, and the content of Sn therein was 55% by weight. The temperature of the test sample was 164° C. at a shrinking percentage of 0.5%, the temperature thereof was 202° C. at a shrinking percentage of 1.0%, and the temperature thereof was 210° C. at a shrinking percentage of 1.5%. The thickness of the surface oxide film was 50 nm. FIG. 2 shows the elemental analysis profile of this silver alloy powder with respect to the depth directions using an X-ray photoelectron spectroscopic analyzer (XPS). In FIG. 2, the oxygen atomic percentage exceeds 9% to show the existence of Ag, Sn and O in a range of sputtering time of 0 to 50 minutes. The range of sputtering time of 0 to 50 minutes corresponds to a depth of 0 to 50 nm in which the surface oxide film exists.

### Example 4

While a molten metal obtained by heating 1.35 kg of shot silver and 1.65 kg of shot tin to 1430° C. in an atmosphere of nitrogen was allowed to drop from the lower portion of a tundish, a high-pressure water was sprayed onto the molten metal at a water pressure of 150 MPa and a water flow rate of 160 L/min. in an atmosphere of nitrogen by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver alloy powder (Ag—Sn alloy powder). Furthermore, an aqueous alkaline solution (pH=10.26) prepared by adding 157.55 g of sodium hydroxide to 21.6 m³ of pure water was used as the high-pressure water.

With respect to the silver alloy powder thus obtained, the BET specific surface area, tap density, oxygen content, carbon content and particle size distribution thereof were obtained by the same methods as those in Example 1, the alloy composition analysis and thermomechanical analysis (TMA) thereof were carried out by the same methods as those in Example 1, and the thickness of the surface oxide film was measured by the same method as that in Example 2.

As a result, the BET specific surface area of the silver alloy powder was 1.37 m²/g, and the tap density thereof was 3.1 g/cm³. The oxygen content in the silver alloy powder was 0.61% by weight, and the carbon content therein was 0.01% by weight. The particle diameter (D₁₀) corresponding to 10% of accumulation in cumulative distribution of the silver alloy powder was 0.5 μm, the particle diameter (D₅₀) corresponding to 50% of accumulation in cumulative distribution of the silver alloy powder was 1.3 μm, and the particle diameter (D₉₀) corresponding to 90% of accumulation in cumulative distribution of the silver alloy powder was 2.4 μm. The content of Ag in the silver alloy powder was 45% by weight, and the content of Sn therein was 55% by weight. The temperature of the test sample was 121° C. at a shrinking percentage of 0.5%, the temperature thereof was 172° C. at a shrinking percentage of 1.0%, and the temperature thereof was 205° C. at a shrinking percentage of 1.5%. The thickness of the surface oxide film was 65 nm.

### Example 5

A silver alloy powder (Ag—Sn alloy powder) was obtained by the same method as that in Example 4, except that the high-pressure water was sprayed in the atmosphere.

With respect to the silver alloy powder thus obtained, the BET specific surface area, tap density, oxygen content, carbon content and particle size distribution thereof were obtained by the same methods as those in Example 1, the alloy composition analysis and thermomechanical analysis (TMA) thereof were carried out by the same methods as those in Example 1, and the thickness of the surface oxide film was measured by the same method as that in Example 2.

As a result, the BET specific surface area of the silver alloy powder was 3.30 m²/g, and the tap density thereof was 3.4 g/cm³. The oxygen content in the silver alloy powder was 1.44% by weight, and the carbon content therein was 0.01% by weight. The particle diameter (D₁₀) corresponding to 10% of accumulation in cumulative distribution of the silver alloy powder was 0.5 μm, the particle diameter (D₅₀) corresponding to 50% of accumulation in cumulative distribution of the silver alloy powder was 1.0 μm, and the particle diameter (D₉₀) corresponding to 90% of accumulation in cumulative distribution of the silver alloy powder was 1.9 μm. The content of Ag in the silver alloy powder was 44% by weight, and the content of Sn therein was 55% by weight. The temperature of the test sample was 106° C. at a shrinking percentage of 0.5%, the temperature thereof was 155° C. at a shrinking percentage of 1.0%, and the temperature thereof was 196° C. at a shrinking percentage of 1.5%. The thickness of the surface oxide film was 55 nm.

### Example 6

A silver alloy powder (Ag—Sn alloy powder) was obtained by the same method as that in Example 2, except that the heating temperature was 1200° C., and that the weights of the shot silver and shot tin were 2.01 kg and 4.69 kg, respectively.

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 1.48 m²/g, and the tap density thereof was 3.3 g/cm³. The oxygen content in the silver alloy powder was 1.11% by weight, and the carbon content therein was 0.01% by weight. The particle diameter (D₁₀) corresponding to 10% of accumulation in cumulative distribution of the silver alloy powder was 0.6 μm, the particle diameter (D₅₀) corresponding to 50% of accumulation in cumulative distribution of the silver alloy powder was 1.5 μm, and the particle diameter (D₉₀) corresponding to 90% of accumulation in cumulative distribution of the silver alloy powder was 3.4 μm. The content of Ag in the silver alloy powder was 30% by weight, and the content of Sn therein was 70% by weight. The temperature of the test sample was 158° C. at a shrinking percentage of 0.5%, the temperature thereof was 195° C. at a shrinking percentage of 1.0%, and the temperature thereof was 206° C. at a shrinking percentage of 1.5%.

### Example 7

While a molten metal obtained by heating 2 kg of shot silver and 2 kg of indium to 1100° C. in an atmosphere of nitrogen was allowed to drop from the lower portion of a tundish, a high-pressure water (pure water having a pH of 5.8) was sprayed onto the molten metal at a water pressure of 150 MPa and a water flow rate of 160 L/min. in the atmosphere by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver alloy powder (Ag—In alloy powder).

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 1.17 m²/g, and the tap density thereof was 3.5 g/cm³. The oxygen content in the silver alloy powder was 1.06% by weight, and the carbon content therein was 0.02% by weight. The particle diameter (D₁₀) corresponding to 10% of accumulation in cumulative distribution of the silver alloy powder was 0.7 μm, the particle diameter (D₅₀) corresponding to 50% of accumulation in cumulative distribution of the silver alloy powder was 1.8 μm, and the particle diameter (D₉₀) corresponding to 90% of accumulation in cumulative distribution of the silver alloy powder was 3.5 μm. The content of Ag in the silver alloy powder was 47% by weight, and the content of In therein was 52% by weight. The temperature of the test sample was 141° C. at a shrinking percentage of 0.5%, the temperature thereof was 166° C. at a shrinking percentage of 1.0%, and the temperature thereof was 178° C. at a shrinking percentage of 1.5%.

### Example 8

While a molten metal obtained by heating 1.5 kg of shot silver and 3.5 kg of zinc to 1000° C. in an atmosphere of nitrogen was allowed to drop from the lower portion of a tundish, a high-pressure water (pure water having a pH of 5.8) was sprayed onto the molten metal at a water pressure of 150 MPa and a water flow rate of 160 L/min. in the atmosphere by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver alloy powder (Ag—Zn alloy powder).

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 1.77 m²/g, and the tap density thereof was 3.3 g/cm³. The oxygen content in the silver alloy powder was 0.84% by weight, and the carbon content therein was 0.02% by weight. The particle diameter (D₁₀) corresponding to 10% of accumulation in cumulative distribution of the silver alloy powder was 1.0 μm, the particle diameter (D₅₀) corresponding to 50% of accumulation in cumulative distribution of the silver alloy powder was 2.3 μm, and the particle diameter (D₉₀) corresponding to 90% of accumulation in cumulative distribution of the silver alloy powder was 4.6 μm. The content of Ag in the silver alloy powder was 57% by weight, and the content of Zn therein was 43% by weight. The temperature of the test sample was 283° C. at a shrinking percentage of 0.5%, the temperature thereof was 356° C. at a shrinking percentage of 1.0%, and the temperature thereof was 419° C. at a shrinking percentage of 1.5%.

### Example 9

While a molten metal obtained by adding 250 g of carbon powder serving as a reducing agent to a molten metal melted by heating 3.5 kg of shot silver and 1.5 kg of shot lead to 1100° C. in an atmosphere of nitrogen was allowed to drop from the lower portion of a tundish, a high-pressure water (the same alkaline water having a pH of 10.26 as that in Example 3) was sprayed onto the molten metal at a water pressure of 150 MPa and a water flow rate of 160 L/min. in the atmosphere by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver alloy powder (Ag—Pb alloy powder).

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 2.14 m²/g, and the tap density thereof was 3.1 g/cm³. The oxygen content in the silver alloy powder was 1.87% by weight, and the carbon content therein was 0.10% by weight. The particle diameter (D₁₀) corresponding to 10% of accumulation in cumulative distribution of the silver alloy powder was 0.7 μm, the particle diameter (D₅₀) corresponding to 50% of accumulation in cumulative distribution of the silver alloy powder was 1.8 μm, and the particle diameter (D₉₀) corresponding to 90% of accumulation in cumulative distribution of the silver alloy powder was 3.6 μm. The content of Ag in the silver alloy powder was 70% by weight, and the content of Pb therein was 27% by weight. The temperature of the test sample was 133° C. at a shrinking percentage of 0.5%, the temperature thereof was 152° C. at a shrinking percentage of 1.0%, and the temperature thereof was 166° C. at a shrinking percentage of 1.5%.

### Example 10

A silver alloy powder (Ag—Pb alloy powder) was obtained by the same method as that in Example 9, except that the weights of the shot silver and shot lead were 1.5 kg and 3.5 kg, respectively.

With respect to the silver alloy powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver alloy powder was 2.41 m²/g, and the tap density thereof was 3.0 g/cm³. The oxygen content in the silver alloy powder was 5.56% by weight, and the carbon content therein was 0.13% by weight. The particle diameter (D₁₀) corresponding to 10% of accumulation in cumulative distribution of the silver alloy powder was 0.6 μm, the particle diameter (D₅₀) corresponding to 50% of accumulation in cumulative distribution of the silver alloy powder was 1.6 μm, and the particle diameter (D₉₀) corresponding to 90% of accumulation in cumulative distribution of the silver alloy powder was 3.5 μm. The content of Ag in the silver alloy powder was 30% by weight, and the content of Pb therein was 64% by weight. The temperature of the test sample was 200° C. at a shrinking percentage of 0.5%, the temperature thereof was 229° C. at a shrinking percentage of 1.0%, and the temperature thereof was 245° C. at a shrinking percentage of 1.5%.

### Comparative Example

While a molten metal obtained by heating 13 kg of shot silver to 1600° C. in an atmosphere of nitrogen was allowed to drop from the lower portion of a tundish, a high-pressure water (pure water having a pH of 5.8) was sprayed onto the molten metal at a water pressure of 150 MPa and a water flow rate of 160 L/min. in the atmosphere by means of a water atomizing apparatus to rapidly cool and solidify the molten metal to obtain a slurry. The solid-liquid separation of the slurry thus obtained was carried out to obtain a solid. The solid thus obtained was washed with water, dried, pulverized and air-classified to obtain a silver powder.

With respect to the silver powder thus obtained, the BET specific surface area, tap density, oxygen content, carbon content and particle size distribution thereof were obtained by the same methods as those in Example 1, and the alloy composition analysis and thermomechanical analysis (TMA) thereof were carried out by the same methods as those in Example 1.

As a result, the BET specific surface area of the silver powder was 0.47 m²/g, and the tap density thereof was 5.1 g/cm³. The oxygen content in the silver powder was 0.07% by weight, and the carbon content therein was 0.01% by weight. The particle diameter (D₁₀) corresponding to 10% of accumulation in cumulative distribution of the silver powder was 0.7 μm, the particle diameter (D₅₀) corresponding to 50% of accumulation in cumulative distribution of the silver powder was 2.1 μm, and the particle diameter (D₉₀) corresponding to 90% of accumulation in cumulative distribution of the silver powder was 4.1 μm. The content of Ag in the silver powder was 100% by weight. The temperature of the test sample was 479° C. at a shrinking percentage of 0.5%, the temperature thereof was 490° C. at a shrinking percentage of 1.0%, and the temperature thereof was 500° C. at a shrinking percentage of 1.5%.

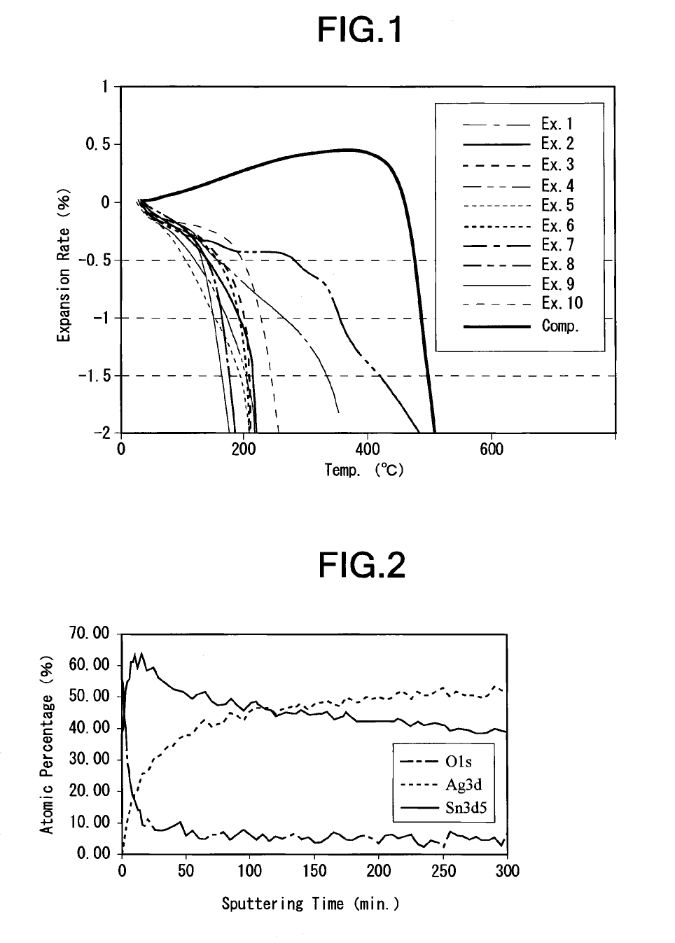

The producing conditions and characteristics of the silver alloy powders in these Examples and silver powder in Comparative Example are shown in Tables 1 through 3. The expansion rates of the silver alloy powders in Examples 1 through 10 and silver powder in Comparative Example with respect to temperature in the thermomechanical analysis (TMA) are shown in FIG. 1.

TABLE 1

| | | | | Atomizing | | |
|---|---|---|---|---|---|---|
| | Molten Metal | | | | | Raw |
| | Temp. | | Reducing | Sprayed | | Material |
| | (° C.) | Atm. | Agent | Water | Atm. | (wt %) |
| Ex. 1 | 1100 | nitrogen | — | alkaline | atm. | Ag75 |
| | | | | (pH 10.26) | | Sn25 |
| Ex. 2 | 1100 | nitrogen | — | pure | atm. | Ag65 |
| | | | | (pH 5.8) | | Sn35 |
| Ex. 3 | 1100 | nitrogen | — | alkaline | atm. | Ag45 |
| | | | | (pH 10.26) | | Sn55 |
| Ex. 4 | 1430 | nitrogen | — | alkaline | nitrogen | Ag45 |
| | | | | (pH 10.26) | | Sn55 |
| Ex. 5 | 1430 | nitrogen | — | alkaline | atm. | Ag45 |
| | | | | (pH 10.26) | | Sn55 |
| Ex. 6 | 1200 | nitrogen | — | pure | atm. | Ag30 |
| | | | | (pH 5.8) | | Sn70 |
| Ex. 7 | 1100 | nitrogen | — | pure | atm. | Ag50 |
| | | | | (pH 5.8) | | In50 |
| Ex. 8 | 1000 | nitrogen | — | pure | atm. | Ag30 |
| | | | | (pH 5.8) | | Zn70 |
| Ex. 9 | 1100 | nitrogen | carbon | alkaline | atm. | Ag70 |
| | | | powder | (pH 10.26) | | Pb30 |
| Ex. 10 | 1100 | nitrogen | carbon | alkaline | atm. | Ag30 |
| | | | powder | (pH 10.26) | | Pb70 |
| Comp. | 1600 | nitrogen | — | pure | atm. | Ag100 |
| | | | | (pH 5.8) | | |

TABLE 2

| | | TAP | | | Particle Size | | |
|---|---|---|---|---|---|---|---|
| | BET | Density | O | C | Distribution (μm) | | |
| | (m²/g) | (g/cm³) | (wt %) | (wt %) | D₁₀ | D₅₀ | D₉₀ |
| Ex. 1 | 0.92 | 3.6 | 0.32 | 0.01 | 0.9 | 2.2 | 4.2 |
| Ex. 2 | 1.14 | 3.5 | 0.57 | 0.01 | 0.8 | 1.9 | 4.0 |
| Ex. 3 | 1.63 | 3.3 | 0.76 | 0.01 | 0.7 | 1.8 | 4.0 |
| Ex. 4 | 1.37 | 3.1 | 0.61 | 0.01 | 0.5 | 1.3 | 2.4 |
| Ex. 5 | 3.30 | 3.4 | 1.44 | 0.01 | 0.5 | 1.0 | 1.9 |
| Ex. 6 | 1.48 | 3.3 | 1.11 | 0.01 | 0.6 | 1.5 | 3.4 |
| Ex. 7 | 1.17 | 3.5 | 1.06 | 0.02 | 0.7 | 1.8 | 3.5 |
| Ex. 8 | 1.77 | 3.3 | 0.84 | 0.02 | 1.0 | 2.3 | 4.6 |
| Ex. 9 | 2.14 | 3.1 | 1.87 | 0.10 | 0.7 | 1.8 | 3.6 |
| Ex. 10 | 2.41 | 3.0 | 5.56 | 0.13 | 0.6 | 1.6 | 3.5 |
| Comp. | 0.47 | 5.1 | 0.07 | 0.01 | 0.7 | 2.1 | 4.1 |

TABLE 3

| | | | | | Thickness |
|---|---|---|---|---|---|
| | TMA Temp. (° C.) | | | Alloy | of Surface |
| | 0.5% | 1.0% | 1.5% | Composition | Oxide |
| | Shrinkage | Shrinkage | Shrinkage | (wt %) | Film (nm) |
| Ex. 1 | 162 | 268 | 335 | Ag74, Sn24 | — |
| Ex. 2 | 142 | 194 | 216 | Ag63, Sn36 | 18 |
| Ex. 3 | 164 | 202 | 210 | Ag45, Sn55 | 50 |
| Ex. 4 | 121 | 172 | 205 | Ag45, Sn55 | 65 |
| Ex. 5 | 106 | 155 | 196 | Ag44, Sn55 | 55 |
| Ex. 6 | 158 | 195 | 206 | Ag30, Sn70 | — |
| Ex. 7 | 141 | 166 | 178 | Ag47, In52 | — |
| Ex. 8 | 283 | 356 | 419 | Ag57, Zn43 | — |
| Ex. 9 | 133 | 152 | 166 | Ag70, Pb27 | — |
| Ex. 10 | 200 | 229 | 245 | Ag30, Pb64 | — |
| Comp. | 479 | 490 | 500 | Ag100 | — |

As can be seen from Tables 1 through 3 and FIG. 1, in Examples 1 through 10, it is possible to produce a silver alloy powder sintered at a lower temperature than that of the silver powder in Comparative Example.

As metal powders, there were prepared the silver alloy powder in Example 2 (65% by weight of Ag and 35% by weight of Sn in the raw material), the silver alloy powder in Example 3 (45% by weight of Ag and 55% by weight of Sn in the raw material), the silver alloy powder in Example 6 (30% by weight of Ag and 70% by weight of Sn in the raw material), the silver powder in Comparative Example (100% by weight of Ag in the raw material), and a tin powder (the particle diameter (D₅₀) corresponding to 50% of accumulation in cumulative distribution of the powder being 1.8 μm). After 89.2% by weight of each of these metal powders, 1.6% by weight of glass frit (ZnO) and 4.0% by weight of TeO₂ serving as additives, 1.2% by weight of ethyl cellulose serving as a resin, and 2.0% by weight of texanol and 2.0% by weight of butyl carbitol acetate (BCA) serving as solvents were preliminarily kneaded by means of a planetary centrifugal vacuum degassing mixer (Awatori Rentaro produced by Thinky Corporation), the metal powder was dispersed by means of a three-roll mill (80S produced by EXAKT Inc.) to prepare a conductive paste. After each of the conductive pastes thus prepared was printed on a silicon wafer by means of a screen printing machine (MT-320T produced by Micro-tech Co., Ltd.) so as to have a linear shape of 500 μm×37.5 mm, it was heated at 200° C. for 10 minutes by means of a hot air type dryer, and then, it was fired at a peak temperature of each of 780° C. and 820° C. for an in-out time of 21 seconds in a fast firing IR furnace (Fast Firing Test Four-Chamber Furnace produced by NGK Insulators Ltd.).

The thickness and electric resistance of each of these conductive films were measured, and the volume resistivity thereof was obtained. As a result, when the conductive paste containing the silver powder in Comparative Example was fired at 780° C., the thickness of the conductive film was 23.4 μm, the electric resistance thereof was 1.39×10⁻¹Ω, and the volume resistivity thereof was 4.35×10⁻⁶Ω ·cm. When the conductive paste containing the silver alloy powder in Example 2 was fired at 780° C., the thickness of the conductive film was 27.5 μm, the electric resistance thereof was 4.00×10⁵Ω, and the volume resistivity thereof was 1.47×10¹Ω·cm. When the conductive paste containing the silver alloy powder in Example 3 was fired at 780° C., the thickness of the conductive film was 28.6 μm, the electric resistance thereof was 4.39×10³Ω, and the volume resistivity thereof was 1.69×10⁻¹ Ω·cm. When the conductive paste containing the silver alloy powder in Example 6 was fired at 780° C., the thickness of the conductive film was 31.0 μm, the electric resistance thereof was 4.04×10¹Ω, and the volume resistivity thereof was 1.67×10⁻³ Ω·cm. When the conductive paste containing the tin powder was fired at 780° C., the thickness of the conductive film was 20.7 g m, the electric resistance thereof was 2.28×10⁶Ω, and the volume resistivity thereof was 6.33×10¹Ω·cm. When the conductive paste containing the silver powder in Comparative Example was fired at 820° C., the thickness of the conductive film was 23.1 μm, the electric resistance thereof was 1.39×10⁻¹Ω, and the volume resistivity thereof was 4.26×10⁻⁶ Ω·cm. When the conductive paste containing the silver alloy powder in Example 2 was fired at 820° C., the thickness of the conductive film was 28.5 μm, the electric resistance thereof was 5.40×10⁴Ω, and the volume resistivity thereof was 2.05×10° Ω·cm. When the conductive paste containing the silver alloy powder in Example 3 was fired at 820° C., the thickness of the conductive film was 29.0 μm, the electric resistance thereof was 1.40×10⁴Ω, and the volume resistivity thereof was 5.39×10⁻¹ Ω·cm. When the conductive paste containing the silver alloy powder in Example 6 was fired at 820° C., the thickness of the conductive film was 30.6 μm, the electric resistance thereof was 3.93×10¹Ω, and the volume resistivity thereof was 1.61×10⁻³ Ω·cm. When the conductive paste containing the tin powder was fired at 820° C., the thickness of the conductive film was 19.7 μm, the electric resistance thereof was 4.78×10⁶Ω, and the volume resistivity thereof was 1.26×10²Ω·cm.

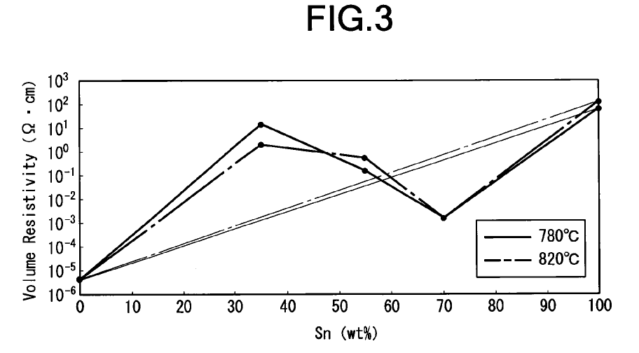

FIG. 3 shows the volume resistivity of each of these conductive films with respect to the content of tin in the metal powder therein. As can be seen from FIG. 3, the conductive film using the silver alloy powder in Example 6 (containing 70% by weight of tin) has a very low volume resistivity although it contains a larger amount of tin than that in the conductive film using each of the silver alloy powder in Example 2 (containing 35% by weight of tin) and the silver alloy powder in Example 3 (containing 55% by weight of tin). It can be seen from this result that it is possible to obtain an inexpensive conductive film having a low volume resistivity if a conductive paste containing an Ag—Sn alloy powder containing 65 to 75% by weight of tin is used.

### INDUSTRIAL APPLICABILITY

The silver alloy powder according to the present invention can be utilized as the material of a baked type conductive paste, which is sintered at a low temperature, in order to form electrodes of solar cells, internal electrodes of laminated ceramic electronic parts, such as electronic parts using low-temperature co-fired ceramics (LTCC) and laminated ceramic inductors, external electrodes of laminated ceramic capacitors or inductors, and so forth.

1. A silver alloy powder comprising silver and a metal which is selected from the group consisting of tin, zinc, lead and indium, the silver alloy powder having an average particle diameter of 0.5 to 20 μm, and the silver alloy powder having a temperature of not higher than 300° C. at a shrinking percentage of 0.5% in a thermomechanical analysis.

2. A silver alloy powder as set forth in claim 1, which has a temperature of not higher than 400° C. at a shrinking percentage of 1.0% in said thermomechanical analysis.

3. A silver alloy powder as set forth in claim 1, which has a temperature of not higher than 450° C. at a shrinking percentage of 1.5% in said thermomechanical analysis.

4. A silver alloy powder as set forth in claim 1, which has an oxygen content of not higher than 6% by weight.

5. A silver alloy powder as set forth in claim 1, which has a carbon content of not higher than 0.5% by weight.

6. A silver alloy powder as set forth in claim 1, which has a BET specific surface area of 0.1 to 3.5 m²/g.

7. A silver alloy powder as set forth in claim 1, which has a tap density of not less than 2.5 g/cm³.

8. A silver alloy powder as set forth in claim 1, which is an alloy powder of tin and silver and which has a tin content of 65 to 75% by weight.

9. A method for producing a silver alloy powder comprising the steps of:
preparing a molten metal by melting silver and a metal, which is selected from the group consisting of tin, zinc, lead and indium, in an atmosphere of nitrogen; and
rapidly cooling and solidifying the molten metal by spraying a high-pressure water onto the molten metal while the molten metal is allowed to drop.

10. A method for producing a silver alloy powder as set forth in claim 9, wherein said high-pressure water is pure water or alkaline water.

11. A method for producing a silver alloy powder as set forth in claim 9, wherein said high-pressure water is sprayed onto the molten metal in the atmosphere or an atmosphere of nitrogen.

12. A conductive paste wherein a silver alloy powder as set forth in claim 1 is dispersed in an organic component.

13. A conductive paste as set forth in claim 12, which is a baked type conductive paste.

14. A method for producing a conductive film comprising the steps of:
applying a baked type conductive paste as set forth in claim 13 on a substrate; and
thereafter, firing the paste to produce a conductive film.
